(19) United States
(12) Patent Application Publication
(10) Pub. No.: US 2004/0144699 A1
(43) Pub. Date: Jul. 29, 2004

(54) Buoyant water chlorinator with range indicators for temperature , pH measurement and chlorine concentration

(76) Inventor: Fong-Jei Lin, Saratoga, CA (US)

Correspondence Address: Warren P. kujawa, 434 Larkin St.#4, Montery, CA, 93940, US

(21) Appl. No.: 10/352,608

(22) Filed: Jan. 27, 2003

(51) Int. Cl. B01D 17/12

(52) U.S. Cl. 210/85; 210/94; 210/198.1; 210/242.1

(57) ABSTRACT

A buoyant water conditioner has a housing with an upper surface and an apertured chamber for receiving a chlorination agent. Three separate measurement systems are carried by the housing: a water temperature system, a pH level system, and an oxidation reduction system. Each system has a sensor for measuring the respective water parameter, a display for displaying the measured value, range indicators for indicating whether or not the measured parameter lies within a predetermined range, and a processor for converting the sensor signals to display driving signals and range indicator activation signals. Each system is powered by a solar cell battery or a chemical battery.

### CROSS-REFERENCE TO RELATED PATENT

This invention is an improvement over the invention disclosed and claimed in commonly-owned U.S. Pat. No. 6,238,553 issued May 29, 2001 for “Buoyant Water Chlorinator With Temperature, pH measurement, and Chlorine Concentration Displays”.

### BACKGROUND OF THE INVENTION

This invention relates generally to water chlorination units of the type used in pools and spas. More particularly, this invention relates to an improved buoyant water chlorination unit with range indicators for temperature, pH measurement, and chlorine concentration.

Water chlorination units are known which are used to supply chlorine to water in pools for water purification. Several such units are buoyant with an inner chamber providing a containment volume for the chlorination material, typically one or more solid pellets, with the containment volume having openings through the walls thereof so that the chlorination material can dissolve in the surrounding water.

The buoyant water chlorinator disclosed and claimed in U.S. Pat. No. 6,238,553 comprises a buoyant housing with a lower apertured chamber for holding chlorine material, such as solid tablets. A removable cover retains the chlorine material in place. A plurality of measurement systems, each microprocessor-based, is carried by the housing. Each system has an easily-readable display, preferably mounted on the periphery of an upper housing surface, each display preferably comprising a liquid crystal display (LCD). One measurement system comprises a temperature sensor, such as a thermistor, for measuring the temperature of the ambient water. Electrical temperature signals produced by this sensor are coupled to a microprocessor programmed to convert these signals to signals capable of driving the associated display. A second measurement system comprises a pH level sensor for measuring the pH level of the ambient water. Electrical signals produced by this sensor are coupled to a microprocessor programmed to convert these signals to signals capable of driving the associated display. The remaining measurement system comprises an oxidation reduction potential sensor in the form of a chlorine concentration sensor for measuring the chlorine concentration of the ambient water. Electrical signals produced by this sensor are coupled to a microprocessor programmed to convert these signals to signals capable of driving the associated display.

Electrical power is supplied to each measurement system from a power source contained within the housing. One suitable power source is a solar cell battery mounted on the same surface as the displays. Another source is a battery installed in a battery compartment. Both types of power source may be included and either source may serve as the primary power source for all systems, with the remaining source reserved as a back-up source, or the two sources may both serve as primary sources for different systems.

The invention is used by placing it in the body of water in a pool or spa and observing the display values at intervals chosen by the user. When the displays indicate that the pH or chlorine concentration values need to be adjusted and that chlorine material must be added to the chlorine chamber, the cover is removed, and the fresh material is dropped into the receptacle chamber.

The National Spa and Pool Institute (NSPI), a standards organization, has published recommended temperature, pH and oxidation reduction potential (which is related to chlorination concentration) ranges for spas and pools. These ranges are intended to guide users of spas and pools in maintaining the water quality for maximum enjoyment, and spa and pool owners are encouraged to maintain the above water parameters within the recommended ranges to ensure this result. While water chlorinator units fabricated in accordance with the teachings of the above-referenced U.S. patent do display the actual values of the water parameters, the user is required to interpolate these actual values in order to determine whether or not a given measured value lies within or outside the recommended range. A water chlorinator unit having range indicators would eliminate this disadvantage, and would thus facilitate the water maintenance of the associated spa or pool.

### SUMMARY OF THE INVENTION

The invention comprises an improved water chlorinator which affords the advantages of real-time measurement of water temperature, pH, and oxidation reduction potential, and also provides temperature, pH and oxidation reduction potential range indications which are readily observable by a user.

In a most general aspect, the invention comprises an improved buoyant water conditioner with a buoyant housing having an upper surface and an apertured chamber for receiving a chlorination agent; and a plurality of measurement systems carried by the housing. Each system includes a sensor for generating signals representative of a water parameter, a display for displaying the value of that parameter, at least one range indicator for indicating whether that parameter lies within a predetermined range, and a processor coupled to the sensor, the at least one range indicator, and the display for converting the sensor signals to display driving signals and range indicator activation signals. A source of electrical power provides power to the systems. The power source can comprise one or more solar cells mounted on a surface of the housing, a chemical battery carried by the housing, or both.

In the preferred embodiment, the measured water parameters are water temperature, the pH value of the water, and the water oxidation reduction potential (ORP). The range indicators used for temperature and ORP comprise two light emitting diodes (LEDs), one colored green for indicating a measured value lying within a recommended value range, and one colored red for indicating a measured value lying outside the recommended value range. The range indicators used for pH comprise three LEDs-one green for indicating a measured pH value lying within a recommended safe range; one colored yellow for indicating a measured pH value lying within a cautionary range; and one colored red for indicating a measured pH value lying outside the cautionary range.

The provision of the visible range indicators provides a visual indication to the user of the relative safety of each measured water parameter. Since the indicators are usually visible from a greater distance than the parameter displays, the invention affords a relatively convenient way of checking the relative safety of each of the monitored water parameters without any need to manipulate the chlorinator to the side of the pool or spa.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a schematic view of the preferred embodiment of the invention;

FIG. 2 is a top plan view of the invention of FIG. 1;

FIG. 3 is a block diagram of the temperature measurement system with range indicators incorporated into the preferred embodiment of the invention;

FIG. 4 is a block diagram of the pH measurement system with range indicators incorporated into the preferred embodiment of the invention; and

FIG. 5 is a block diagram of the chlorine concentration measurement system with range indicators incorporated into the preferred embodiment of the invention.

### DETAILED DESCRIPTION OF THE PREFERRED EMBODIMENTS

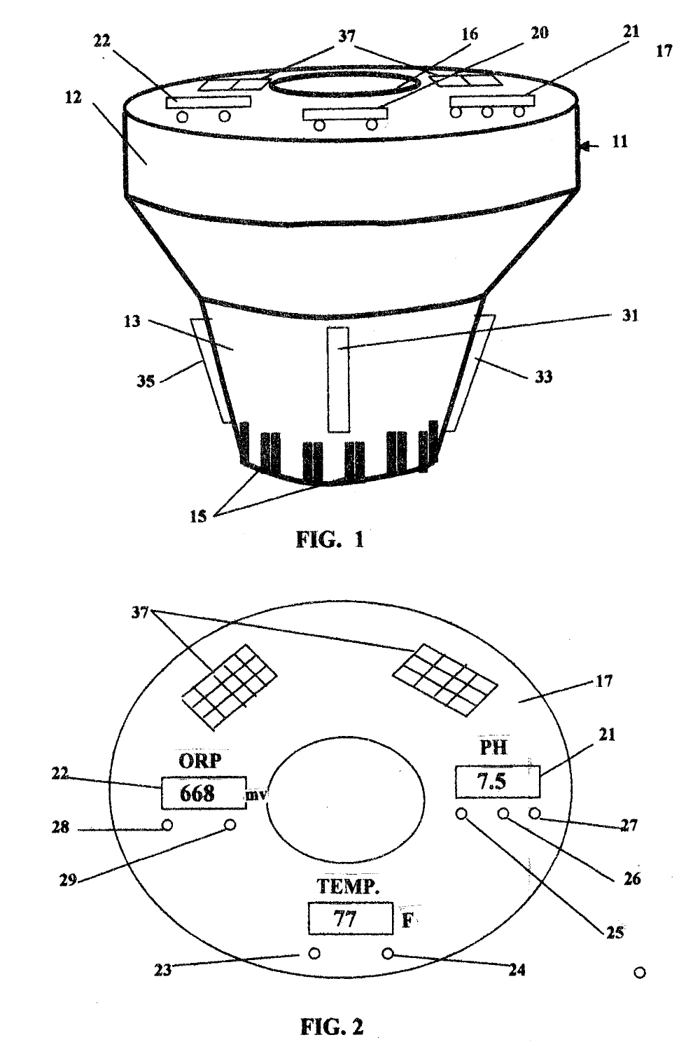

Turning now to the drawings, FIG. 1 is a schematic view illustrating the preferred embodiment of the invention. As seen in this Fig., the preferred embodiment includes a housing 11, typically made from plastic material. Housing 11 has an upper sealed hollow space 12 to ensure buoyancy in water, and a lower wall portion 13 providing a hollow interior for receiving one or more water-soluble chlorine tablets (not shown). A plurality of adjustable openings 15 are distributed about the circumference of lower wall portion 13 to allow water to enter the hollow interior volume and leach chlorine from the tablets. A cover 16 is removably mounted to the top of housing 11. To add more chlorine tablets, cover 16 is removed to expose the hollow lower interior.

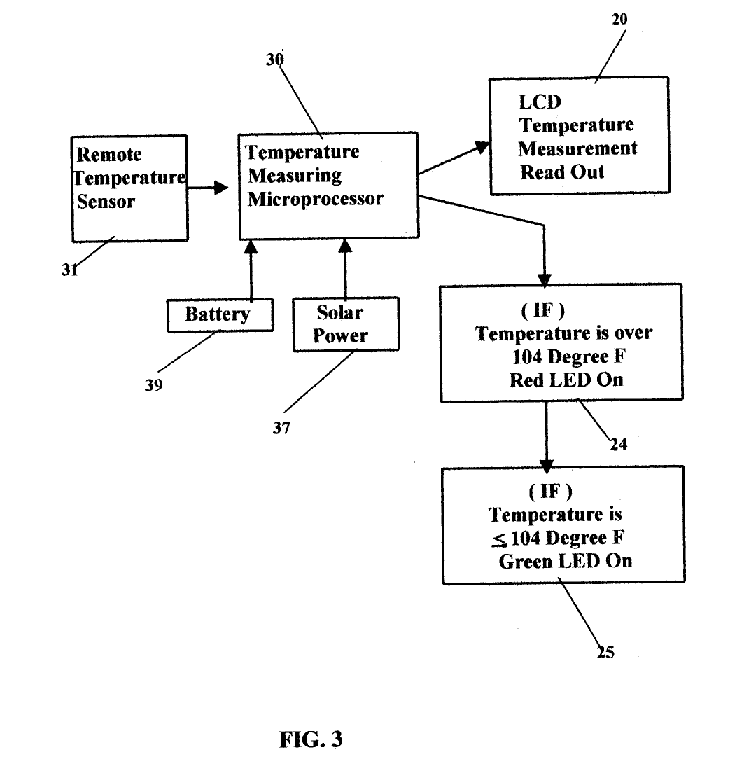

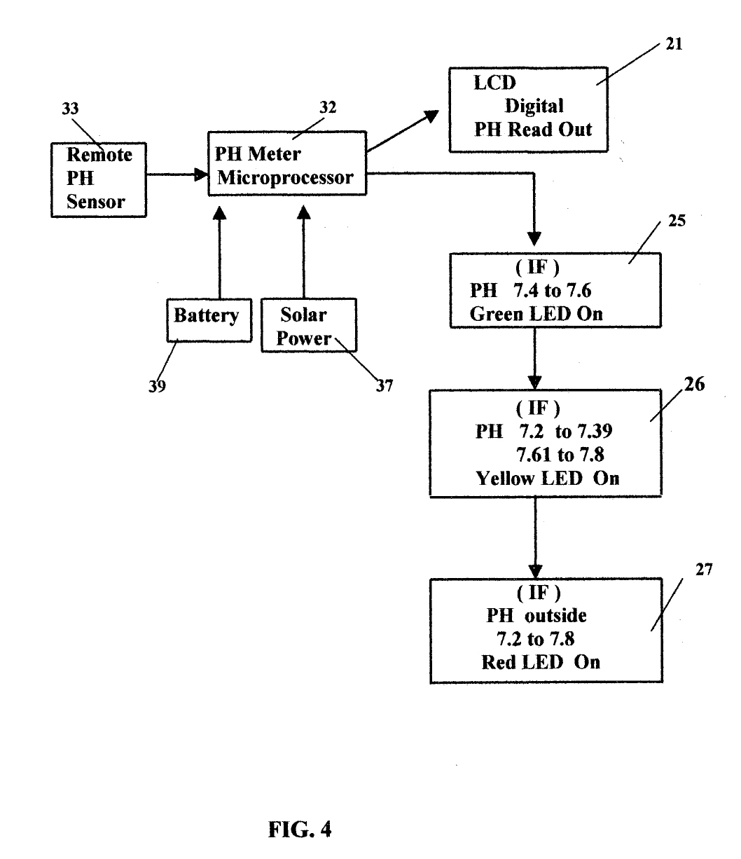

Arranged about the upper peripheral surface 17 of housing 11 are three liquid crystal (LCD) displays 20-22. Display 20 is a water temperature display and is electrically coupled to a microprocessor-based temperature processing unit 30 shown in FIG. 3, which receives water temperature measurement signals from a temperature sensor 31. Display 21 is a pH level display and is electrically coupled to a microprocessor-based pH level processing unit 32 shown in FIG. 4, which receives pH level signals from a pH electrode 33. Display 22 is an oxidation reduction (ORP) display and is electrically coupled to a microprocessor-based chlorine concentration processing unit 34, which receives signals from an oxidation reduction potential sensor 35.

Mounted adjacent water temperature display 20 are a pair of visible range indicators 23, 24. In the preferred embodiment, range indicator 23 is a green light emitting diode (LED), and range indicator is a red LED. Mounted adjacent pH level display 21 are three visible range indicators 25-27. In the preferred embodiment, range indicator 25 is a green LED, range indicator 26 is a yellow LED, and range indicator 27 is a red LED. Mounted adjacent ORP display 22 are a pair of visible range indicators 28, 29. In the preferred embodiment, range indicator 28 is a green LED, and range indicator 29 is a red LED. Each range indicator 23-29 is coupled to the associated microprocessor-based parameter processing unit and is activated in the manner described below to provide a visible indication to the user of the range state of the associated parameter.

Electrical power is supplied to the displays 20-22, LED indictors 23-29, sensors 31, 33, and 35, and processing units 30, 32, and 34 by one or more solar cells 37 mounted on the upper peripheral surface 17 of housing 11. An alternate source consisting of a battery (not shown) mounted in an appropriate portion of housing 11 is also provided.

FIG. 3 is a block diagram of the water temperature measurement system described above. As seen in this FIG., remote temperature sensor 31, which may comprise any one of a number of commercially available devices capable of generating signals representative of the temperature with which the unit 31 comes in contact (such as a thermistor), has an output electrically coupled to the microprocessor unit 30. Microprocessor unit 30 may comprise any known microprocessor capable of receiving the signals from sensor 31 and converting these signals to signals capable of operating display 20. The display output of microprocessor unit 30 is electrically coupled to the display input terminals of display 20, which displays temperature value in the form of integers plus an indication of the scale employed (i.e., Fahrenheit, Celsius, or some other scale).

Microprocessor 30 also incorporates a range decision routine which examines the current value of the water temperature parameter and compares this value to a predetermined maximum recommended water temperature value. In the preferred embodiment, this value is 104 degrees Fahrenheit (40 degrees Celsius). If the measured water temperature value is no greater than the maximum recommended value, green LED 24 is activated by microprocessor 30. If the measured water temperature value is greater than the maximum recommended value, red LED 25 is activated by microprocessor 30.

FIG. 4 is a block diagram of the pH measurement system described above. As seen in this FIG., remote pH electrode 33 has a signal output electrically coupled to the microprocessor unit 32. Electrode 33 may comprise any one of a number of commercially available sensors capable of generating electrical signals representative of the pH level of water with which the electrode 33 comes in contact (such as the sensor component incorporated into the series H-58800 pH meters available from ATI-Orion Research, Inc.). Microprocessor unit 32 may comprise the same type of unit as microprocessor unit 30, with different programming to convert the pH input signals to signals capable of operating display 21. The display output of microprocessor 32 is electrically coupled to the display input terminals of display 21, which displays pH values in the normal form of an integer, a decimal point and another integer.

Microprocessor 32 also incorporates a range decision routine which examines the current value of the pH parameter and compares this value to a predetermined range of recommended pH values. In the preferred embodiment, this range is 7.4 to 7.6 for safe use; 7.2 to 7.39 and 7.61 to 7.8 for marginal or cautionary use; and not recommended use for pH values below 7.2 and above 7.8. If the measured pH value is within the safe use range, green LED 25 is activated by microprocessor 32. If the measured pH value is within the marginal use range, yellow LED 26 is activated by microprocessor 32. If the measured pH value is outside the marginal or cautionary use range (either lower or higher), red LED 27 is activated by microprocessor 32.

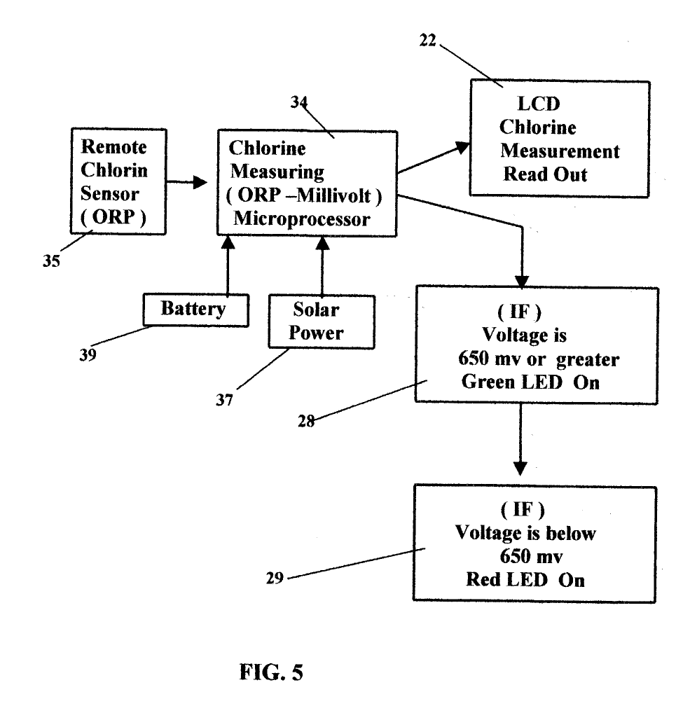

FIG. 5 is a block diagram of the ORP chlorine concentration system described above. As seen in this FIG., chlorine sensor 35 has a signal output electrically coupled to microprocessor 34. Sensor 35 may comprise any one of a number of known sensors capable of generating signals representative of the ORP (usually in millivolts) of water with which sensor 35 comes in contact. The ORP is related to chlorine concentration in a known manner. Microprocessor unit 34 may comprise the same type of unit as microprocessor unit 30, with different programming to convert the ORP signals supplied by sensor 35 to signals capable of operating display 22. The display output of microprocessor unit 34 is coupled to the input terminals of display 22, which displays ORP in the form of three integers and the legend “mv”.

Microprocessor 34 also incorporates a range decision routine which examines the current value of the ORP parameter and compares this value to a predetermined minimum recommended ORP value. In the preferred embodiment, this value is 650 mv. If the measured ORP value is equal to or greater than the minimum recommended value, green LED 28 is activated by microprocessor 34. If the measured ORP value is less than the minimum recommended value, red LED 29 is activated by microprocessor 34.

As illustrated in FIGS. 3-5, each unit is electrically powered by either solar cells 37, a battery 39, or a combination of the two. More specifically, if one or two of the systems shown in FIGS. 3-5 draws substantially more power than the others, either the solar cells 37 or the battery 39 may be dedicated to the unit(s) with a higher power consumption, with the remaining power source shared among all three systems. In the alternative, one of the two power sources (e.g., solar cells 37) may serve as the principal power source for all three units, and the other source used as a back-up source.

As will now be apparent, the invention provides all of the advantages of the invention disclosed in the above-referenced U.S. patent, and in addition provides an instantly recognizabe visual indication of the range state of each parameter. Moreover, the visible LED indicators 23-29 can usually be viewed from a distance greater than that required to read the individual parameter displays 20-22, so that a user can visually check the relative safety of the water by means of a simple visual inspection from poolside. As a result, pool water maintenance is simplified and made more precise through use of the invention.

Although the above provides a full and complete disclosure of the preferred embodiments of the invention, various modifications, alternate constructions and equivalents will occur to those skilled in the art. For example, although the invention has been described with reference to LED indicators 23-29, other types of indicator lamps which are readily visible in the water environment (such as bright sunlight) may be employed. Moreover, although at least two indicators are used in the preferred embodiment for each measured water parameter, in some applications it may be desirable to use only a single indicator-such as one red indicator or one green indicator- to indicate whether or not the measured parameter is within the recommended or acceptable range. In addition, LED indicators 23-29 may be mounted on the housing in other locations than the upper peripheral surface shown. It is preferable to locate each set of LED indicators 23-29 adjacent the associated display 20-22 in order to facilitate association of LED indicators and displays. Further, although the invention has been described with reference to separate microprocessors for each measurement system, a single microprocessor with mutliplexed input ports may be employed, as desired. Also, the invention may be configured with less than all of the three systems, if deemed useful or desirable. Still further, additional parameter measurement systems, such as separate chlorine concentration and ORP measurement systems, may be incorporated into the invention. Therefore, the above should not be construed as limiting the invention, which is defined by the appended claims.

What is claimed is:

1. An improved buoyant water conditioner comprising:
a buoyant housing having an upper surface and an apertured chamber for receiving a chlorination agent;
a plurality of measurement systems carried by said housing, each said system having a sensor for generating signals representative of a water parameter, a display for displaying the value of that parameter, at least one range indicator for indicating whether that parameter lies within a predetermined range, and a processor coupled to said sensor, said at least one range indicator, and said display for converting the sensor signals to display driving signals and range indicator activation signals; and
a source of electrical power for providing power to said systems.

2. The invention of claim 1 wherein one of said measurement systems comprises a water temperature measurement system.

3. The invention of claim 1 wherein one of said measurement systems comprises a pH level measurement system.

4. The invention of claim 1 wherein one of said measurement systems comprises an ORP measurement system.

5. The invention of claim 1 wherein each said display is mounted on said upper surface of said housing.

6. The invention of claim 1 wherein each said display comprises a liquid crystal display.

7. The invention of claim 1 wherein said source of electrical power comprises a solar cell battery.

8. The invention of claim 1 wherein said source of electrical power comprises a chemical battery.

9. The invention of claim 1 wherein said source of electrical power is mounted on said upper surface of said housing.

10. The invention of claim 1 wherein each said range indicator is mounted adjacent the associated display.

11. A buoyant water conditioner comprising:
a buoyant housing having an upper surface and an apertured chamber for receiving a chlorination agent;
a plurality of measurement systems carried by said housing:
a first one of said measurement systems including a pH sensor for generating signals representative of water pH level, a pH level display for displaying the value of the water pH, three pH range indicators, and a processor coupled to said pH sensor, said pH level display, and said pH range indicators for converting the pH sensor signals to pH level display driving signals and for activating said pH range indicators in accordance with the value of said pH sensor signals;
a second one of said measurement systems including an ORP sensor for generating signals representative of the water oxidation reduction potential, an ORP display for displaying the value of the water oxidation reduction potential, two ORP range indicators, and a processor coupled to said ORP sensor, said ORP display, and said ORP range indicators for converting the ORP sensor signals to ORP display driving signals and for activating said ORP range indicators in accordance with the value of said ORP sensor signals; and
a source of electrical power for providing power to said systems.

12. The invention of claim 11 further including a water temperature sensor for generating signals representative of water temperature, a water temperature display, two temperature range indicators, and a processor coupled to said water temperature sensor, said water temperature display, and said temperature range indicators for converting the water temperature sensor signals to water temperature display driving signals and for activating said temperature range indicators in accordance with the value of said water temperature sensor signals.

13. The invention of claim 11 wherein each said display is mounted on said upper surface of said housing.

14. The invention of claim 11 wherein each said display comprises a liquid crystal display.

15. The invention of claim 11 wherein said source of electrical power comprises a solar cell battery.

16. The invention of claim 11 wherein said source of electrical power comprises a chemical battery.

17. The invention of claim 11 wherein said source of electrical power is mounted on said upper surface of said housing.

18. The invention of claim 11 wherein each said range indicator is mounted adjacent the associated display.
